(19) United States
(12) Patent Application Publication
(10) Pub. No.: US 2009/0266495 A1
(43) Pub. Date: Oct. 29, 2009

(54) FOLDABLE SCREEN DEVICE

(75) Inventors: Shuuji Karasawa, Tokyo (JP); Yoji Kamosawa, Tokyo (JP); Masato Moriya, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Seiki Hanbai Co., Ltd., Nerima-ku (JP)

(21) Appl. No.: 12/094,274

(22) PCT Filed: Nov. 8, 2006
(86) PCT No.: PCT/JP2006/322291

§ 371 Date: May 20, 2008

(30) Foreign Application Priority Data
Nov. 30, 2005 (JP) 2005-347210

(51) Int. Cl. E06B 9/06

(52) U.S. Cl. 160/84.03

(57) ABSTRACT

In a folding screen device pulled in the lateral direction, the widthwise dimension limit of the screen device in the opening and closing direction of the screen is eliminated. A plurality of screen units include movable vertical frame members attached to both ends of a screen expandable in an accordion manner. The vertical frame members are slidable along a lateral frame member of a building opening. Screen guides in the screen units move out and into the interior of the vertical frame member through upper and lower ends thereof in a bent state, and are led along upper and lower ends of the screen in an extended state. A parallel movement mechanism causes the vertical frame members to move in parallel during opening and closing of the screen. The screen units can be arranged in parallel in the building opening by connecting adjacent vertical frame members of the screen units.

### TECHNICAL FIELD

The present invention relates to a folding screen device in which a screen expandable in an accordion manner can be opened and closed by pulling in the lateral direction for the purpose of insect screening, light shielding, hiding, heat insulation or the like.

### BACKGROUND ART

In a folding screen device in which a screen expandable in an accordion manner can be opened and closed by pulling in the lateral direction, the one provided with a screen guide for guiding an end of the screen by moving out and into the interiors of the upper end and the lower end of at least one of frame members attached to both ends of the screen in a bent state and being led out along the end of the screen in the extended state is known by, for example, Patent Document 1.

Since the screen device of this type can avoid arrangement of a large member which guides the lower end of the screen on the lower side of an opening of a building in a screen-opened state in which the screen is completely folded and stored, it is simple in appearance and does not hinder passage of pedestrians, wheelchairs or the like, and hence it is quite effective in a point that it can adapt barrier-free structure.

Therefore, in the screen device of this type, it is necessary to configure the extended width of the screen guide within a range in which the screen can be led completely into the interior of the frame member in the screen-opened state in which the screen is completely folded and stored, and hence the widthwise dimension of the screen device in the direction of opening and closing the screen is limited and, in particular, in the case in which the opening of the building is wider than the height, the screen device may be difficult to mount.

In addition, even though the widthwise dimension of the product can be increased by any means, the distance of movement of the operating frame in association with the opening and closing operation of the screen is increased, and hence difficulties may be occurred during opening and closing operation, or the operation may take a lot of trouble.
Patent Document 1: Japanese Unexamined Patent Application Publication No. 2005-36518

### DISCLOSURE OF INVENTION

### Problems to be Solved by the Invention

It is a technical subject of the present invention to provide the folding screen device including a screen guide for guiding the upper end and the lower end of the screen by moving out and into the interior of the upper end and the lower end of vertical frame members attached to both ends of the screen in a bent state and being led along the upper end and the lower end of the screen in the extended state, in which a plurality of unitized screen units are joined to each other so that the required number of the screen units can be arranged in parallel, whereby the limit of the widthwise dimension of the screen device in the direction of opening and closing the screen is eliminated.

It is another technical subject of the present invention to provide the folding screen device whose limit of the widthwise dimension of the screen device in the direction of opening and closing the screen is eliminated and, simultaneously, whose widthwise dimension is increased, wherein the screen can be opened and closed at a desired position of the screen units arranged in parallel.

It is still another technical subject of the present invention to provide a screen device in which maintenance of the screen unit, or replacement of the screen or a wire inserted thereto can be performed easily.

### Means for Solving the Problems

In order to solve the above described problems, a folding screen device in the present invention includes screen units each having a screen being expandable in an according manner by being folded alternately in the opposite direction at a number of bending portions provided in parallel at regular intervals and being openable and closable by pulling in the lateral direction, and movable vertical frame members attached at both ends of the screen so as to be capable of sliding along a lateral frame member at an opening of a building, the screen unit including screen guides moving out and into the interiors of the vertical frame members through the upper ends and the lower ends thereof in a bent state and being led along the upper end and the lower end of the screen in an extended state for guiding the upper end and the lower end of the screen, and a horizontal movement mechanism for causing the movable vertical frame members to move in parallel during the opening and closing operation of the screen, wherein the adjacent vertical frame members of the plurality of screen units are disconnectably connected to each other so that the screen units can be arranged in parallel in the opening of the building.

According to a first preferred embodiment of the folding screen device in the present invention, the pair of the screen guides in the screen unit are fixed at one ends thereof to the upper end and the lower end of one of the vertical frame members and are arranged so as to move out and into the interior of the other vertical frame member through the upper end and the lower end in a bent state, while according to a second preferred embodiment, the pair of screen guides in the screen unit are fixed to the upper end of one of the vertical frame members and the lower end of the other vertical frame member respectively and arranged so as to move out and into the interior of the opposed vertical frame members through the upper end and the lower end in a bent state.

According to the first preferred embodiment of the folding screen device in the present invention, a parallel movement mechanism for causing the vertical frame members to move in parallel during opening and closing operation of the screen is configured by looped wire rotatably extended between the upper and lower portions in the interior of the vertical frame member which the screen guide moves out or into, and the portions thereof which move in the opposite directions are connected to ends of the respective screen guides.

According to the first preferred embodiment of the folding screen device in the present invention, the wire attached at one end thereof to the screen unit on the side of one of the vertical frame members, having inserted through the screen in the horizontal direction, is guided to the upper end of the other vertical frame member via redirecting means provided on the other frame member, is suspended from the upper end into the other vertical frame member, and is attached with a weight at the distal end thereof in the other vertical frame member, so that the screen can be automatically folded and stored.

In this case, at least three of the screen units can be supported by the lateral frame member at the opening of the building and inhibiting means for inhibiting the screen from being automatically folded by the weight in a state in which the screen is extended, whereby, even when the widthwise dimension of the screen device is increased, the screen can be opened and closed at a desired position of the screen units arranged in parallel.

According to the first preferred embodiment of the folding screen device, mounting plates fixed to both ends of the screen are disengageably engaged to the vertical frame members with the mounting members respectively, the wire to be inserted through the screen and attached with the weight being suspended at the distal end thereof is fixed at one end thereof to the mounting plate engaged with one of the vertical frame member and is detachably attached with the weight at the distal end of the wire suspending from the upper end of the other vertical frame member, and the other vertical frame member is provided with an operation opening for attaching and detaching the weight to the distal end of the wire and an insertion path for inserting the wire is configured to facilitate insertion and removal of the wire.

On the other hand, according to the second preferred embodiment of the folding screen device in the present invention, the parallel movement mechanism for causing the vertical frame members to move in parallel during the opening and closing operation of the screen is configured in such a manner that the one end of the wire to be inserted through the upper half of the screen in the horizontal direction is fixed to the vertical frame member which the screen guide moves out therefrom and therein through the upper end thereof, and the other end of the wire is led toward the lower portion in the other vertical frame member and is redirected upward in the lower portion, and is fixed at the distal end thereof to the distal end of the screen guide which moves out and into the vertical frame member through the lower end thereof, while one end of the wire to be inserted through the lower half of the screen in the horizontal direction is fixed to the vertical frame member which the screen guide moves out therefrom and therein through the lower end thereof and the other end of the wire is led toward the upper portion in the other vertical frame member, is redirected downward at the upper portion, and is fixed to the distal end of the screen guide which moves out and into the other vertical frame member through the upper end thereof.

According to the folding screen device, the mounting plates fixed to both ends of the screen is disengageably engaged with the vertical frame member respectively with the mounting members, while the wires inserted through the upper half and the lower half of the screen are fixed to the mounting plates engaged at one ends thereof to the mounting plates engaged with the vertical frame members respectively, having inserted at the other ends thereof through the mounting plate of the other vertical frame member, are led to the lower portion and the upper portion along the mounting plate, are redirected to the opposite direction at the lower portion and the upper portion, are detachably fixed at the distal ends thereof to the distal ends of the screen guides which moves out and into the vertical frame member through the upper end and the lower end, so that the screen through which the wires are inserted can be separated from the both vertical frame members together with the mounting plates on the both ends thereof by separating the distal end of the respective wires from the distal ends of the screen guides.

Furthermore, according to the preferred embodiment of the folding screen device in the present invention, the upper ends of the pairs of vertical frame members of the respective screen units are fitted and held in a supporting groove of the lateral frame member on the upper portion of the opening of the building, and rails for preventing the upper ends of the screen units from coming apart by engaging with projections provided on the upper ends of the respective vertical frame members are provided at the opening edges of the supporting groove, the rails are formed with slits for allowing passage of the projections, and the slits are closed by caps detachable with respect to the lateral frame member. The projections may be formed of rollers which roll on the rails.

### ADVANTAGES OF THE INVENTION

According to the folding screen device of the present invention described in detail above, in the folding screen device including a screen guide for guiding the upper end and the lower end of the screen by moving out and into the interior of the upper end and the lower end of vertical frame members attached to both ends of the screen in a bent state and being led along the upper end and the lower end of the screen in the extended state, a plurality of unitized screen units are joined to each other so that the required number of the screen units can be arranged in parallel, whereby the limit of the widthwise dimension of the screen device in the direction of opening and closing the screen is eliminated.

In the folding screen device whose limit of the widthwise dimension is eliminated and, simultaneously, whose widthwise dimension is increased, the screen can be opened and closed at a desired position of the screen units arranged in parallel, as well as maintenance of the screen unit, or replacement of the screen or a wire inserted thereto can be performed easily.

### BEST MODE FOR CARRYING OUT THE INVENTION

FIG. 1 to FIG. 16 shows a first embodiment of a folding screen device according to the present invention. As shown in FIG. 4 and FIG. 5, a screen device 1 generally includes a lateral frame member 3 to be mounted to the upper portion of an opening 2 of a building and a plurality of screen units 10 which is capable of sliding along the lateral frame member 3. The screen units 10 each includes a screen 12 which can be opened and closed by pulling laterally, and can be arranged in parallel by an adequate number so as to match the widthwise dimension of the opening 2 of the building in the direction of opening and closing the screen 12, whereby the widthwise dimension of the screen device 1 can be extended arbitrarily so as to match the width of the opening 2 of the building.

As shown in FIG. 1 and FIG. 2, the screen unit 10 includes the screen 12 which is adapted to be expandable in an accordion manner by folding alternately in the opposite direction at a number of bending portions arranged in parallel at regular intervals. This embodiment illustrates a case in which the screen 12 is configured as an insect screening net which can be opened and closed by pulling laterally.

A movable vertical frame member 13 that accommodates the screen guides 20A, 20B, described later, moving into and moving out the upper end and the lower end thereof is attached to an end of the screen 12, and a movable vertical frame member 14 is attached to the other end of the screen 12, so that the screen 12 can be opened and closed along the lateral frame member 3 of the opening 2 of the building in the screen unit 10 and, simultaneously, the screen unit 10 is adapted to be capable of sliding along the lateral frame member 3. In this case the vertical frame members 13, 14 of the plurality of screen units 10 adjacent to each other are detachably connected to each other by connecting means including a magnet 17 and an adsorbing plate 18 which is adsorbed thereto, whereby a plurality of screen units 10 can be operated to open and close entirely by the opening and closing operation of some of screen units 10. The connecting means is not limited to the magnet and the adsorbing plate.

In this configuration, even though the widthwise dimension in the direction of opening and closing of the screen 12 is increased, the screen 12 can be extended over the entire width of the opening 2 of the building (see FIG. 4). Since the screen unit 10 is capable of sliding along the lateral frame member 3 in itself, the both vertical frame members 13, 14 can be used for the opening and closing operation of the screen 12, so that the screen can be opened entirely or partly by the desired screen unit 10 installed at the opening 2 of the building (see FIG. 5).

In addition, since the screen unit 10 is configured to be able to store the screen 12 between the both vertical frame members 13, 14 when the screen 12 is folded between the vertical frame members 13, 14, the lateral width of the screen unit 10 is very small when the screen is folded and hence the opening of the building can be widely opened.

The screen guides 20A, 20B which move out and into the interior of the one vertical frame member 13 of the screen unit 10 through the upper end and the lower end in a bent state and are led out or in along the upper end and the lower end of the screen 12 in the extended state are configured by connecting a number of guiding pieces 21 with a flexible wire 22 as shown in FIG. 1, FIG. 2 and FIG. 6.

The guiding pieces 21 each are formed substantially into a U-shape by a bottom portion 21a which extends along the upper end and the lower end of the screen 12 and upright wall portions 21b extending upright along the outer surface of the screen 12, includes through holes 21c for inserting the wires 22 along the upper end portions of the upright wall portions 21b of each guiding piece 21, and are connected by inserting the lengths of wires 22 through the respective through holes 21c of each guide piece 21 so as to be capable of bending only in the direction in which the wires are inserted. The ends of the wires 22 are fixed to the outer ends of the guide pieces 21 at both ends of the screen guides 20A, 20B so as to be prevented from coming apart.

The screen guides 20A, 20B, moving out and into the interior of the vertical frame member 13 through the upper end and the lower end in a bent state at the end on one side and being fixed to the upper end and the lower end of the other vertical frame member at the end on the other side, are led out and in the interior of the vertical frame member 13 through the upper and lower ends according to the opening and closing operation of the screen 12 in association with the movement of the vertical frame member 13 or the vertical frame member 14, thereby guiding the upper end and the lower end of the screen 12 and, simultaneously, constituting the upper and lower frame members of the screen unit 10 in itself.

As shown in FIG. 1, the vertical frame member 13 which the screen guides 20A, 20B move out and into is provided with a parallel movement mechanism which causes the vertical frame members 13, 14 to move stably in parallel during the opening and closing operation of the screen 12 in cooperation of a loop wire 24 rotatably extended between the upper and lower portions in the interior of the vertical frame member 13 and the screen guides 20A, 20B.

In other words, the wire 24 is rotatably extended in a loop shape between redirecting members (rollers) 23a, 23b provided in the upper and lower portions of the interior of the vertical frame member 13, and portions thereof which move in the opposite directions are connected to the guide pieces 21 at the distal ends of the respective screen guides 20A, 20B led into the vertical frame member 13 at the connecting portions 24a. Therefore, the screen guides 20A, 20B guide the upper and lower ends of the screen 12 and, simultaneously, cause the screen guides 20A, 20B to move out and into the vertical frame member 13 by a corresponding length, whereby the vertical frame members 13, 14 can be moved stably in parallel.

A guide rail 4 is provided on a floor surface of the opening 2 of the building for guiding the movement of the screen guide 20B led along the lower end of the screen 12 along a predetermined course in order to achieve a stable sliding movement of the screen guide 20B which guides the lower end of the screen 12 along the predetermined course, that is, in order to achieve a stable opening and closing of the screen 12. The guide piece 21 is provided with guide ridges 21d on both sides on the back surface of the bottom portion 21a thereof, so that the screen guide 20B is able to slide along the guide rail 4 stably by fitting the guide ridges 21d on the outsides of the guide rail 4. As shown in FIG. 1 and FIG. 3, the height of the guide rail 4 is as low as it does not hinder passage of pedestrian or wheelchairs.

On the other hand, the lateral frame member 3 which guides the movement of the screen unit 10 at the upper portion of the opening 2 of the building is provided with pending walls 3a on the front and rear side thereof, is formed with a supporting groove 3d for slidably fitting and holding the upper ends of the pair of vertical frame members 13, 14 of the respective screen units 10 between the pair of pending walls 3a, and is provided with a pair of rails 3b along the opening edges of the supporting groove 3d, and the respective vertical frame members 13, 14 is provided with projections 15, 16 that engage the rails 3b when the screen unit 10 slants on the front and rear surface at the upper ends thereof for restraining the upper end of the screen unit 10 from coming apart from the supporting grooves 3d due to the slanting of the screen unit 10 in itself.

The projections 15, 16 are formed of rollers that roll on the rails 3b. In the folding screen device according to the first embodiment in the drawing, the positions of the projections 15, 16 are illustrated on the upper end side of the vertical frame members 13, 14 in order to explain a mode of insertion and removal of the upper end of the screen unit 10 to/from the supporting groove 3d of the lateral frame member 3 as will be described in conjunction with FIG. 14 and FIG. 16 later. However, the projections (rollers) 15, 16 roll actually on the rails 3b as shown in FIG. 7. The projections 15, 16 do not necessarily have to be rollers.

As will be understood from FIG. 8(a), FIG. 8(b), FIG. 9(a) and FIG. 9(b), mounting plates 25a, 25b formed of synthetic resin, aluminum, or the like are attached to both ends of the screen 12 in the direction of expansion, while screen 12 mounting surfaces of the vertical frame members 13, 14 are formed with engaging grooves 13b, 14b by pairs of engaging strips 13a, 13a and 14a, 14b extending in the longitudinal direction in a state of facing to each other so as to extend along the screen 12 mounting surface, and the both ends of the screen 12 are detachably attached to the vertical frame members 13, 14 by fitting a plurality of mounting members 28 in the engaging grooves 13b, 14b in a state in which the mounting plates 25a, 25b attached to the screen 12 are engaged with the engaging grooves 13b, 14b on the respective vertical frame members.

The mounting members 28 each includes a leaf spring portion 28a which can expand and contract in the direction of the width of the vertical frame members 13, 14 by being formed of a flexible synthetic resin into a loop on one side thereof, and a plate portion 28b and ridges 28c formed on one surface of the plate portion 28b used for engaging and disengaging operation on the other side. The ridges 28c are used to compress the leaf spring portion 28a by hooking a projecting object or the like when engaging and disengaging the mounting member 28 with respect to the engaging grooves 13b, 14b on the vertical frame members 13, 14.

Therefore, when fitting the mounting members 28 to the engaging grooves 13b, 14b in the vertical frame members 13, 14, the leaf spring portion 28a is compressed in a state in which the plate portion 28b is inserted inside one of the engaging strips 13a, 14a of the engaging grooves 13b, 14b, and in this state, the plate portion 28b is fitted inside the other one of the engaging strips 13a, 14a of the engaging grooves 13b, 14b. In contrast, when detaching the mounting member 28 out from the engaging grooves 13b, 14b, the projecting object such as nail is hooked between the ridges 28c formed on the plate portion 28b of the mounting member 28 and compressing the leaf spring portion 28a, so that they can be detached out from the engaging grooves 13b, 14b (see FIG. 9(a) and FIG. 9(b)).

Wires 30a to 30c are inserted through the screen 12 in multi levels in the horizontal direction respectively at substantially regular intervals on the upper and lower portions and an intermediate portion therebetween, and one ends of the respective wires 30a-30c is fixed to the mounting plate 25a at the end of the screen 12 attached on the side of the vertical frame member 13. The other ends of the wires 30a-30c, after having inserted through the screen 12 in the horizontal direction, are passed through sliding members, not shown, and the wires 30b, 30c except for the upper wire 30a are redirected upward by redirecting means formed by the sliding members and led upward in a groove 29 (see FIG. 9(b)) provided on the screen 12 mounting surface of the vertical frame member 14, and then as shown in FIG. 8(b) and FIG. 10, these wires are led into the vertical frame member 14 through the upper leading port 14c of the vertical frame member 14 together with the upper wire 30a, and are extended downward via a redirection guide 14d at the lower edge of the leading port 14c, and a weight 32 is detachably attached to the distal ends of the wires 30a-30c via a hook 33 in the vertical frame member 14 so as to be suspended therefrom.

The wires 30a-30c inserted through the screen 12 may be suspended separately in the vertical frame member 14 with the weights 32 provided at the distal ends thereof, or alternatively, may be suspended altogether. In this manner, when the plurality of wires 30a-30c are inserted through the screen 12 in multi levels and a force of the weight 32 is applied to the wires 30a-30c, the wires can function as a parallel movement mechanism for causing the vertical frame members 13, 14 to move in parallel by the tensile force applied substantially uniformly to the respective wires 30a-30c, and can prevent the screen 12 from swelling leeward due to an action of a wind pressure or the like.

The mode of extension of the respective wires 30a-30c is not limited to the mode described above.

The weight of the weight 32 to be suspended at the distal ends of the wires 30a-30c may be the weight sufficient for supplementing the folding force of the screen 12, and may be the weight which can fold the screen by the gravitational force of the weight 32 to open the screen 12 from the extended state automatically when the connection between the vertical frame members 13, 14 of the adjacent screen unit 10 with a magnet or the like is released from the state in which the screen is extended.

However, when the lateral frame member 3 at the opening 2 of the building supports three or more of the screen units 10, the screen 12 can be opened partly by providing inhibiting means that inhibit automatic folding of the screen 12 by the weight 32 in the state in which the screen 12 is extended on all or some of the screen units 10 so that the screens 12 of the respective screen units 10 are completely folded by the gravitational force of the weight 32 and hence the opening 2 of the building is restrained from being fully opened when the connection by the magnet or the like between the vertical frame members 13, 14 of the adjacent screen units 10 is released.

As the inhibiting means for inhibiting the automatic folding of the screen 12 by the weight 32, for example, means for supporting the weight 32 by an operator such as a pin which acts on the weight 32 from the outside through the vertical frame member 14 to stop the action of the weight instantaneously, or means for enabling instantaneous detachment of the weight 32 or replacement of the weight 32 with a light one easily may be employed in all or some of the screen units 10.

As described above, in the screen unit 10, since the mounting plates 25a, 25b fixed to the both ends of the screen 12 are disengageably engaged with the vertical frame members 13, 14 respectively by the mounting members 28, the wires 30a-30c are fixed at the one ends thereof to the mounting plates 25a, and are inserted through the mounting plates 25b and suspended from the upper end of the vertical frame member 14 at the other ends thereof with the weight 32 detachably attached to the distal ends thereof, the screen 12 can be detached from the vertical frame members 13, 14 and the screen guides 20A, 20B together with the wires 30a-30c for maintenance of the screen unit 10 or replacement of the screen 12 as shown in FIG. 13.

As shown in FIG. 9(b) and FIG. 12, the vertical frame member 14 is provided with an operation opening 35 for attaching and detaching the weight 32 to the distal ends of the wires for achieving easy detachment of the wires 30a-30c from the vertical frame member 14, the opening 35 is closed with a detachable lid 36, and an insertion path 14c for inserting the wires 30a-30c are configured to facilitate insertion and removal of the wires.

More specifically, the insertion path 14c for inserting the wires 30a-30c are configured, as shown in FIG. 10 and FIG. 11, not only in such a manner that the wires can be inserted therethrough together with the hooks 33 at the distal ends thereof, but also in such a manner that a hole 14e which is larger than an entrance of the insertion path 14c of the vertical frame member 14 is provided on the opposite side surface opposing to the entrance so that the hook 33 can be inserted straight from the entrance of the insertion path 14c and led to the hole 14e (see FIG. 11), so that the hook 33 can be dropped again from the hole 14e into the vertical frame member 14 easily with the aid of an inclined surface at the lower portion of the hole, whereby the inserting operation of the hook 33 and the wire into a narrow space in the vertical frame member 14 is facilitated. Mounting of the weight 32 to the hook 33 can be performed easily through the opening 35 with the lid 36 opened.

As described above, the screen unit 10 is provided with projections 15, 16 that engage the rails 3b when the screen unit 10 slants at the upper ends of the vertical frame members 13, 14 for preventing the upper end of the screen unit 10 from coming apart from the supporting grooves 3d on the lateral frame member 3 due to the slanting of the screen unit 10 in itself, the rails 3b are formed with slits 3c for allowing passage of the projections 15, 16 at the centers thereof for mounting the screen unit 10 to the lateral frame member 3 or allowing detachment from the lateral frame member 3 for maintenance or the like, and the slits are closed by caps 38 detachably attached to the lateral frame member 3 (see FIG. 1, FIG. 14 and FIG. 16).

FIG. 15(a) and FIG. 15(b) show a mode of attaching and detaching the caps 38 to the slits 3c. The lateral frame member 3 is provided with small holes 3e at portion of the lower edges of the pending walls 3a corresponding to the slits 3c formed by cutting off the rails 3b for fixing the caps 38 with screws 39, while the caps 38, being formed of synthetic resin, metal or the like, each have a surface 38a that closes the slits 3c at a level flush with the surface of the rail 3b, and have a cut groove 38b for being fitted to the lower edge of the pending wall 3a of the lateral frame member 3 and a screw hole 38c for being fixed with the screw 39 through the small hole 3e provided on the pending wall 3a of the lateral frame member 3.

Therefore, the caps 38 can be fixed to the slits 3c by screwing the screws 39 into the screw holes 38c in the state shown in FIG. 15(a), and the caps 38 can be detached as shown in FIG. 15(b) by pulling out the caps 38 from the pending walls 3a of the lateral frame member 3 in the state shown in the same drawing, so that the screen unit 10 can be attached to the lateral frame member 3 or detached from the lateral frame member 3.

As shown in FIG. 14, when detaching the screen unit 10 from the lateral frame member 3, the caps 38 fixed to the lower edges of the pending walls 3a are removed as shown in FIG. 14 to open the slits 3c of the rails 3b of the lateral frame member 3 (see FIG. 14), and then, the screen unit 10 is slanted and the projections 16, 15 provided at the upper ends of the vertical frame members 14, 13 are extricated in sequence from the slits 3c, so that the screen unit 10 can be removed from the lateral frame member 3, as shown in FIG. 16. In contrast, when mounting the screen unit 10 to the lateral frame member 3, the screen unit 10 can be attached to the lateral frame member 3 in reverse order.

FIG. 17 and FIG. 18 illustrate a second embodiment of the invention, and a folding screen device 5 in the second embodiment is configured in such a manner that a pair of screen guides 50A, 50B of screen units 40, which correspond to the screen unit 10 in the first embodiment, are fixed at one ends to an upper end of one vertical frame members 44 and an lower end of the other vertical frame member 43, and are arranged so that the other ends move out and into the upper ends and the lower ends of the vertical frame members 43, 44 oppose to each other, thereby being led along the upper end and the lower end of the screen 42 which is expandable in an accordion manner as the one described above in an extended state to guide the upper end and the lower end of the screen 42. The configurations of the screen guides 50A, 50B in themselves are the same as those in the first embodiment described in conjunction with FIG. 6. Since the principal point of the second embodiment which differs from the first embodiment is the configuration of installation of the screen guides 50A, 50B and the configuration of portions related thereto, and other configurations are substantially the same, the configuration of the principal point will be mainly described in the following description.

Mounting plates 55a, 55b fixed to both ends of the screen 42 are engaged with engaging grooves (corresponding to the engaging grooves 13b, 14b in the first embodiment) formed by the engaging strips which correspond to the pairs of engaging strips 13a, 13a and 14a, 14a in the first embodiment (see FIG. 8(a), FIG. 8(b), FIG. 9(a) and FIG. 9(b)) and, in this state, are disengageably engaged with the vertical frame members 43, 44 by fitting a plurality of mounting members 28 into the engaging grooves.

When operating the screen 42 to open and close, a plurality of wires 54a-54c inserted through the screen 42 in the horizontal direction and the pair of upper and lower screen guides 50A, 50B described above are used as the parallel movement mechanism for moving the movable vertical frame members 43, 44 in parallel. Unlike the wires 30a-30c in the first embodiments, the wires 54a-54c do not function to open the opening of the building by folding the screen in the extended state, but constitute the parallel movement mechanism for the vertical frame members 43, 44 as described below.

In other words, the wire 54a inserted horizontally in the upper half side of the screen 42 is fixed at one end thereof to the mounting plate 55a engaged with the vertical frame member 43 which the screen guide 50A moves out and into through the upper end thereof, inserted at the other end thereof through the screen 42 and the mounting plate 55b of the other vertical frame member 44, led to the lower portion thereof along the mounting plate 55b, is redirected upward by the redirecting member 53a provided at the lower portion, and is fixed at the distal end thereof to the distal end of the screen guide 50B moving out and into the vertical frame member 44 through the lower end thereof. On the other hand, the wires 54b, 54c inserted horizontally through the lower half side of the screen 42 are fixed at one ends thereof to the mounting plate 55b engaged with the vertical frame member 44 which the screen guide 50B moves out and into through the lower end thereof and inserted at the other ends thereof through the mounting plate 55a of the vertical frame member, led to the upper portion thereof along the mounting plate 55a, are directed downward by the redirecting member 53b provided at the upper portion, and are fixed at the distal ends thereof to the distal end of the screen guide 50A moving out and into the vertical frame member 43 from the upper end thereof.

In this configuration, the respective screen guides 50A, 50B are led out and in along the upper side and the lower side of the screen 42 in association with the opening and closing operation of the screen 42 by the vertical frame members 43, 44 and guide the upper and lower ends of the screen 42 and, simultaneously, the lengths of the wires 54a-54c between the mounting plates 55a, 55b are changed by a length corresponding to the amount of movement of the distal ends of the both screen guides 50A, 50B, so that the vertical frame members 43, 44 can be moved stably in parallel as a result.

The folding screen device 5 is configured in such a manner that the screen 42 through which the wires 54a-54c are inserted through can be separated from the both vertical frame members 43, 44 together with the mounting plates 55a, 55b at both ends for maintenance of the screen unit 40 or replacement of the wires 54a-54c.

In other words, as shown in FIG. 18, since the mounting plates 55a, 55b fixed to both ends of the screen 42 are disengageably engaged with the respective vertical frame members 43, 44 by the mounting members 28, as described above, they can be separated from the both vertical frame members 43, 44. In addition, since the wires 54a-54c inserted through the upper half and the lower half of the screen 42 are fixed at one ends thereof to the mounting plates 55a, 55b engaged with the vertical frame members 43, 44 respectively, the wires can be separated from the both vertical frame members 43, 44 together with the mounting plates 55a, 55b. Since the other ends of the wires 54b, 54c, having inserted through the mounting plates 55a, 55b of the other vertical frame members 43, 44, are guided toward the lower portion and the upper portion in the recessed groove (the same recessed groove as the recessed groove 29a in the first embodiment) provided on the screen 12 mounting surfaces of the vertical frame members 43, 44 along the mounting plates, are redirected to the opposite direction by the redirecting members 53a, 53b provided on the vertical frame members 43, 44 at the lower portion and the upper portion, and are detachably fixed to the distal ends of the screen guides 50A, 50B which move into and out the upper end and the lower end of the vertical frame members 43, 44 at the distal ends thereof, the screen 42 through which the wires 54a-54c are inserted can be detached from the both vertical frame members 43, 44 together with the mounting plates 55a, 55b at both ends thereof by separating the distal ends of the respective wires 54a-54c from the distal ends of the screen guides 50A, 50B. The vertical frame members 43, 44 may be provided with the operation opening for attaching and detaching the distal ends of the respective wires 54a-54c to the distal ends of the screen guides 50A, 50B as needed.

As is clear from the description given above, the screen device 5 is configured in such a manner that the screen 42 can be opened and closed along the lateral frame member 3 provided at the opening 2 of the building in the screen unit 40 and, simultaneously, the plurality of screen units can be slid along the lateral frame member 3. The adjacent vertical frame members 43, 44 in the plurality of screen units 40 are disconnectably connected to each other by connecting means including a magnet 47 and an adsorbing plate 48 for adsorbing the same, whereby the plurality of screen units 40 can be operated to open and close entirely by the opening and closing operation of a part of the screen units 40.

In order to cause the screen guide 50B for guiding the lower end of the screen 42 to be capable of sliding stably along the predetermined course as in the case of the screen device in the first embodiment, the guide rail 4 for guiding the movement of the screen guide 50B led out along the lower end of the screen 42 is provided on the floor surface at the opening 2 of the building. Then, as shown in FIG. 6, by fitting the guide ridges 21d provided on the both side ends of the back surfaces of the bottom portions 21a thereof of the screen guide 50B to the outside of the guide rail 4, the screen guide 50B can slide stably along the guide rail 4.

On the other hand, the lateral frame member 3 that guides the movement of the screen unit 40 on the upper portion of the opening 2 of the building, having substantially the same configuration as in the case of the first embodiment, is formed with a supporting groove (3d in FIG. 3) for slidably fitting and holding the upper ends of the pair of vertical frame members 43, 44 of the respective screen units 40, is provided with the pair of rails 3b at the opening edges of the supporting groove, and is provided with projections 45, 46 for restraining the upper ends of the screen units 40 from coming apart from the supporting groove 3d due to the slanting thereof.

Although the projections 45, 46 are formed of rollers that roll on the rails 3b as in the case of the first embodiment, they do not necessarily have to be rollers.

Although slits for allowing passage of the projections 45, 46 are provided at the centers of the rails 3b so that the screen units 40 can be mounted to the supporting groove 3d of the lateral frame member 3 or demounted from the lateral frame member 3, and the slits are closed by the caps 38 detachable to the lateral frame member 3, since the configuration is not different from the one described in the first embodiment, the description thereof is omitted here.

### BRIEF DESCRIPTION OF THE DRAWINGS

FIG. 1 is a front view partly broken showing a first embodiment of a folding screen device according to the present invention.

FIG. 2 is a top cross-sectional view of the same.

FIG. 3 is a side end view of the same.

FIG. 4 is a front view showing a state in which the folding screen device is installed and a screen is extended in an opening of a building.

FIG. 5 is a front view showing a state in which part of screen units are opened in the folding screen device in FIG. 4.

FIG. 6 is an enlarged perspective view showing a principal portion showing a configuration of a screen guide.

FIG. 7 is a partial front view showing a relative configuration between a lateral frame member and projections (rollers).

FIG. 8(a) is a partial perspective view for explaining a mode of detaching the screen to a vertical frame member 13.

FIG. 8(b) is a partial perspective view for explaining the mode for detaching the screen to the vertical frame member 13.

FIG. 9(a) is a partial cross-sectional view for explaining a mode for attaching and detaching the mounting member in FIG. 8(a).

FIG. 9(b) is a partial cross-sectional view for explaining a mode for attaching and detaching the mounting member in FIG. 8(b).

FIG. 10 is a partial front cross-sectional view for explaining a mode of leading wires into the vertical frame member.

FIG. 11 is a partial front perspective view for explaining a mode of leading wires into the vertical frame member.

FIG. 12 is a partial perspective view for explaining a mode of attaching and detaching a weight to the distal ends of the wires.

FIG. 13 is an exploded front view for explaining a mode for attaching and detaching a screen through which wires are inserted to/from the vertical frame member and the screen guide.

FIG. 14 is a front view for explaining the sequence of detaching a screen unit from the lateral frame member.

FIG. 15(a) is a partial enlarged side cross-sectional view for explaining a mode of detaching caps to the lateral frame member.

FIG. 15(b) is a partial enlarged side cross-sectional view for explaining the mode of detaching the caps to the lateral frame member.

FIG. 16 is a front view for explaining the sequence of detaching the screen unit from the lateral frame member.

FIG. 17 is a partly broken front view showing a second embodiment of the folding screen device according to the present invention.

FIG. 18 is an exploded front view for explaining a mode of attaching and detaching the screen through which the wires are inserted to/from the vertical frame member and the screen guide.

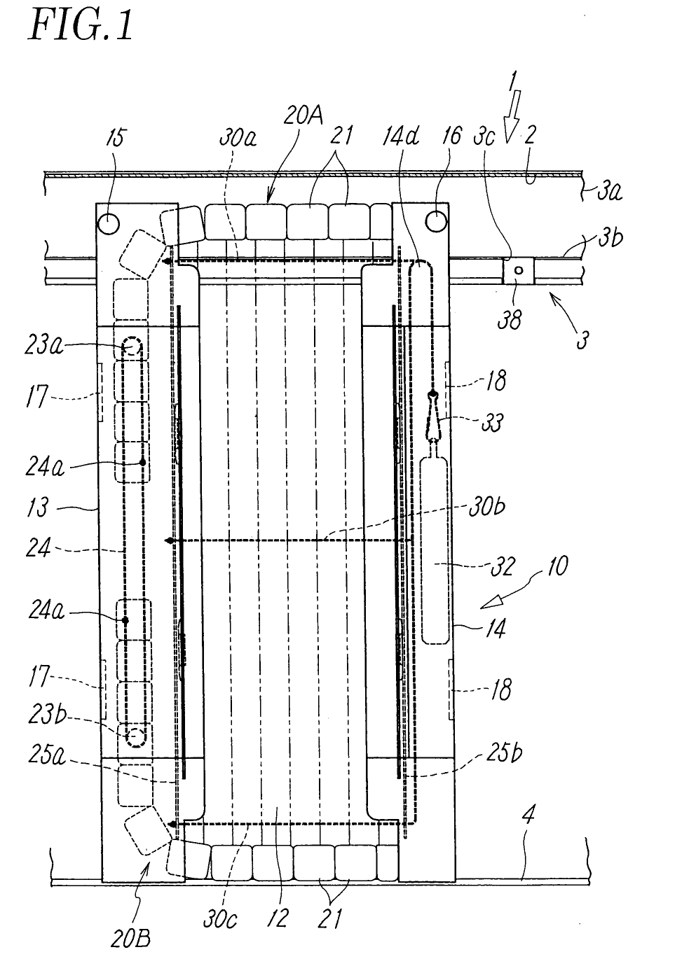

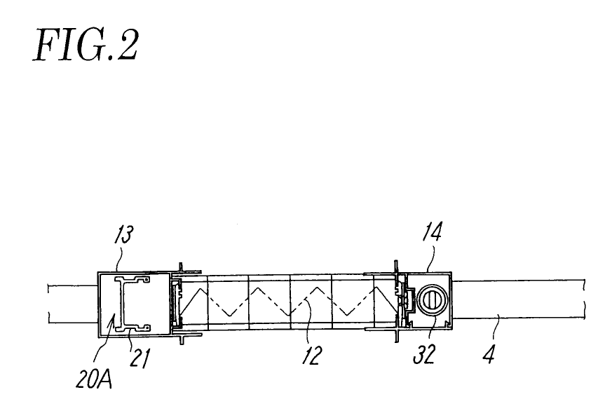

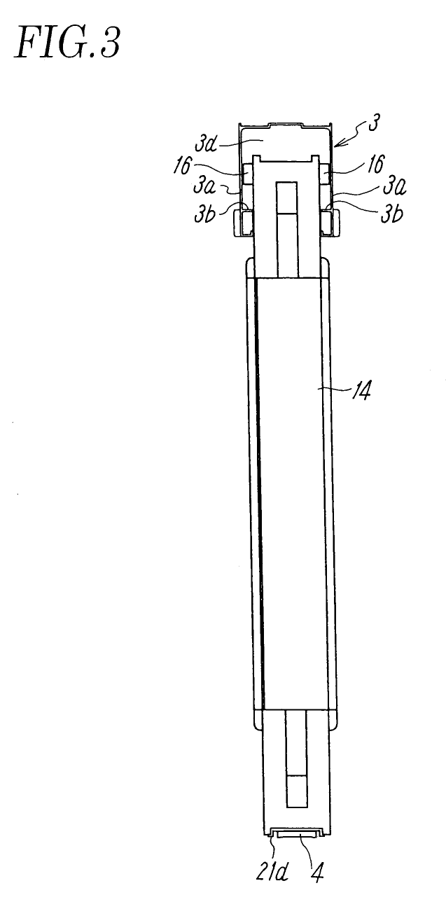

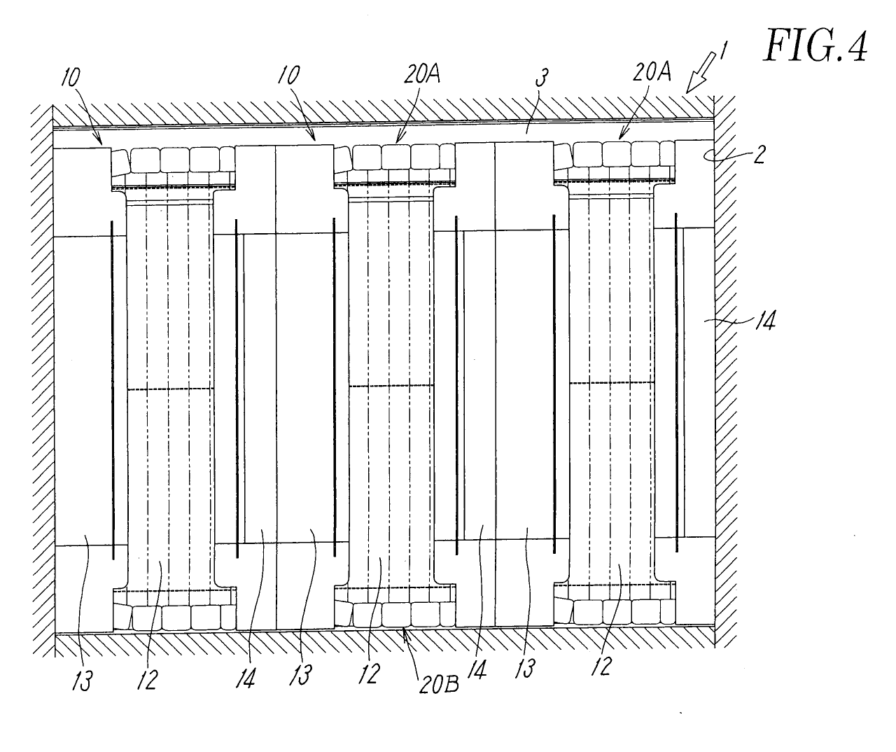

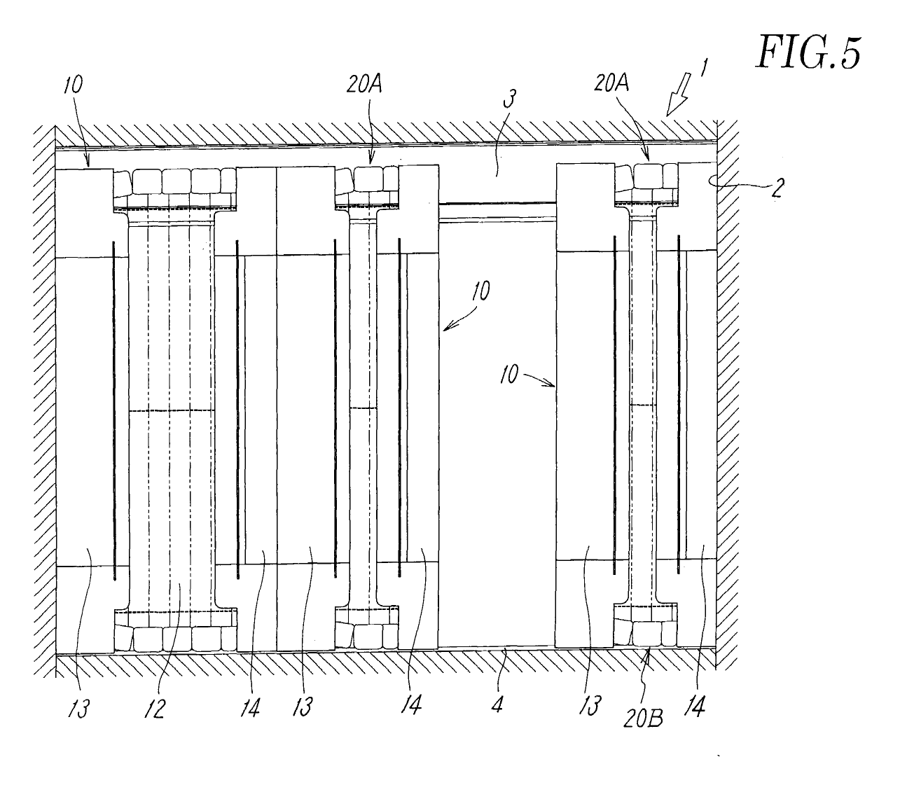

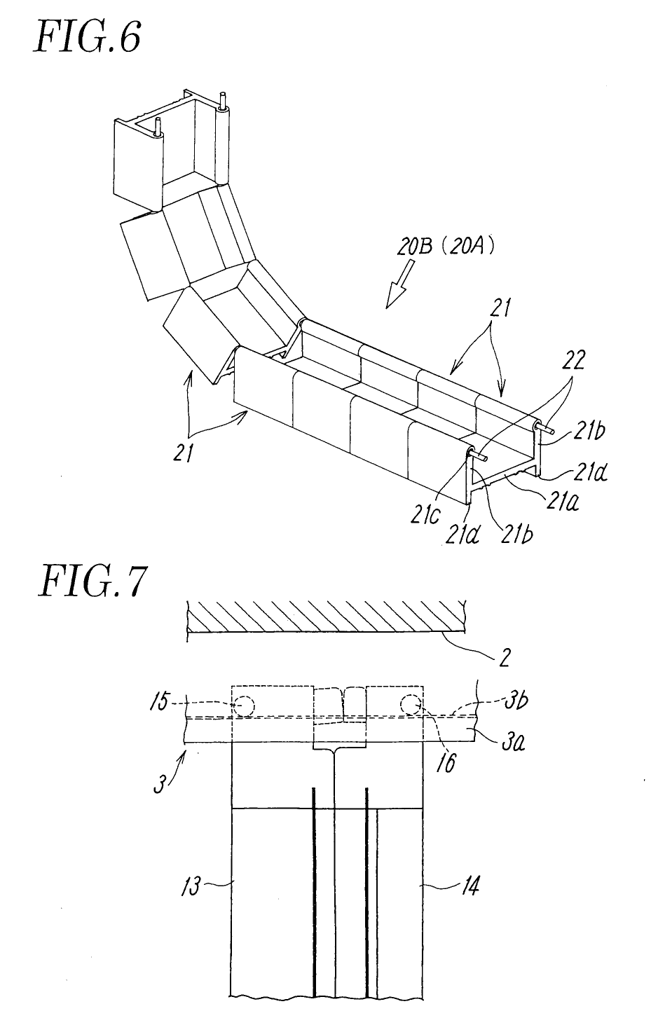

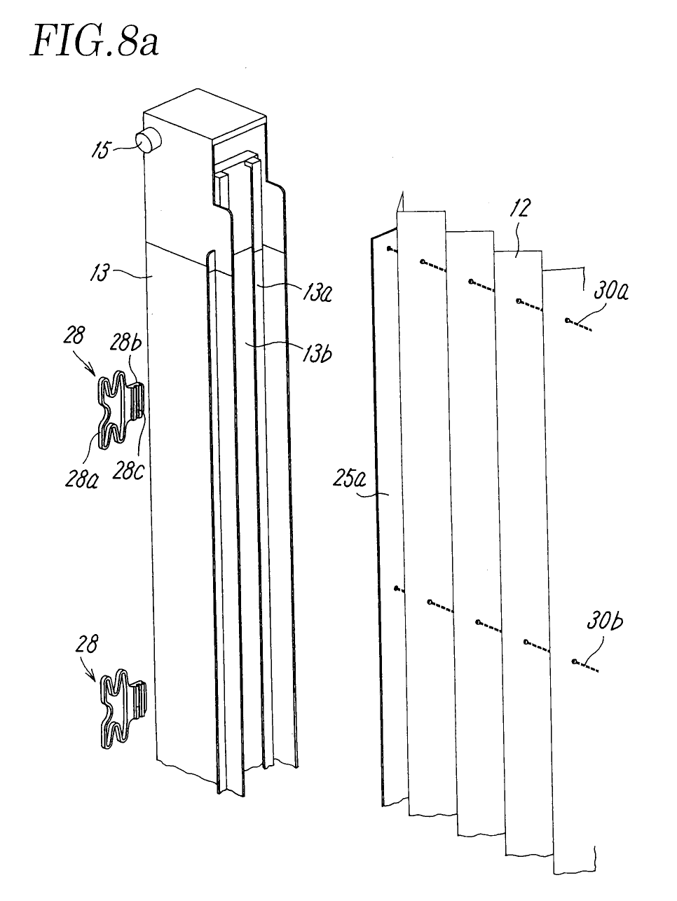

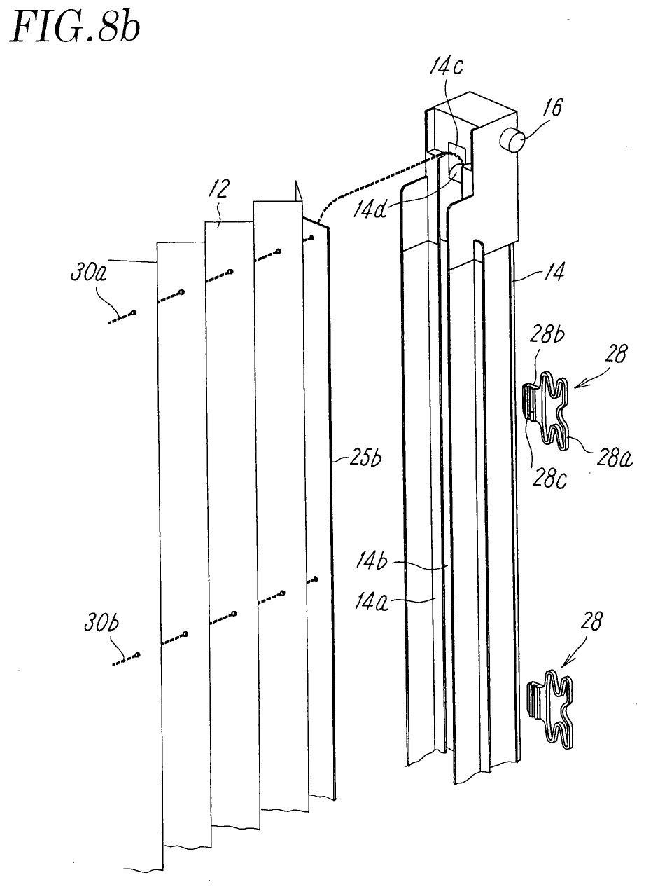

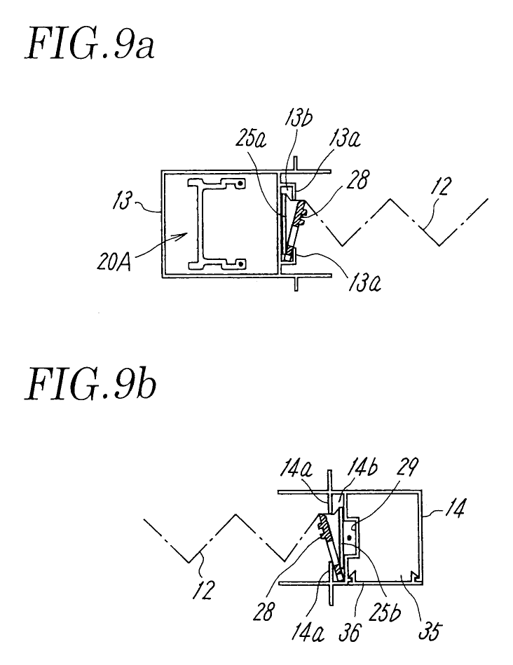

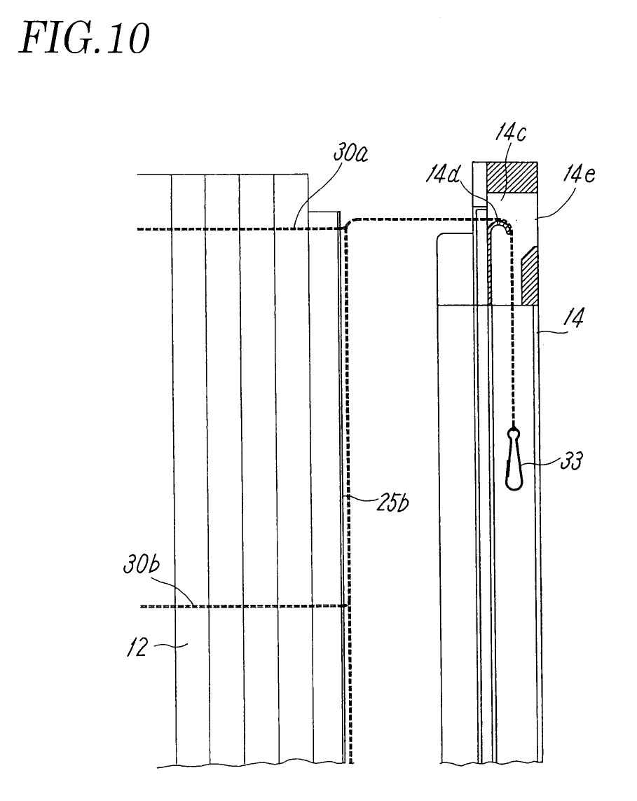

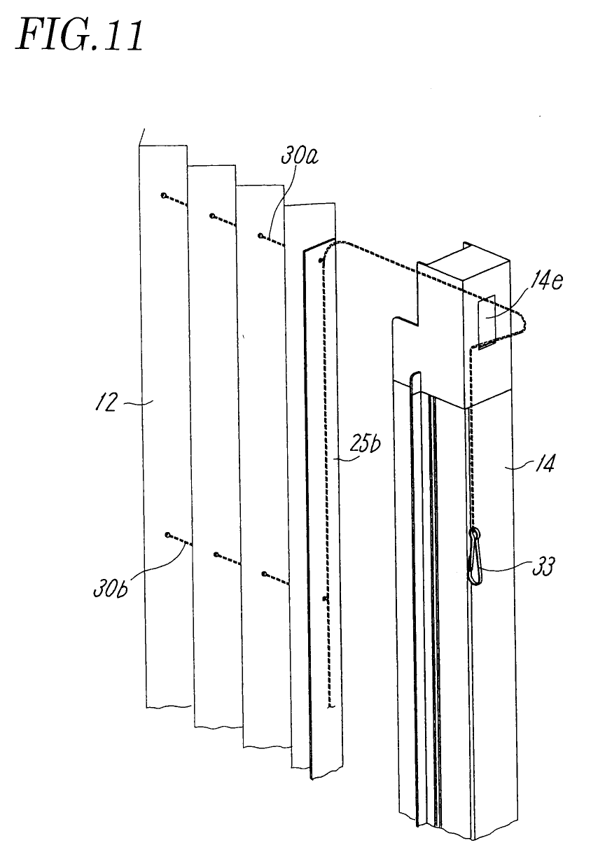

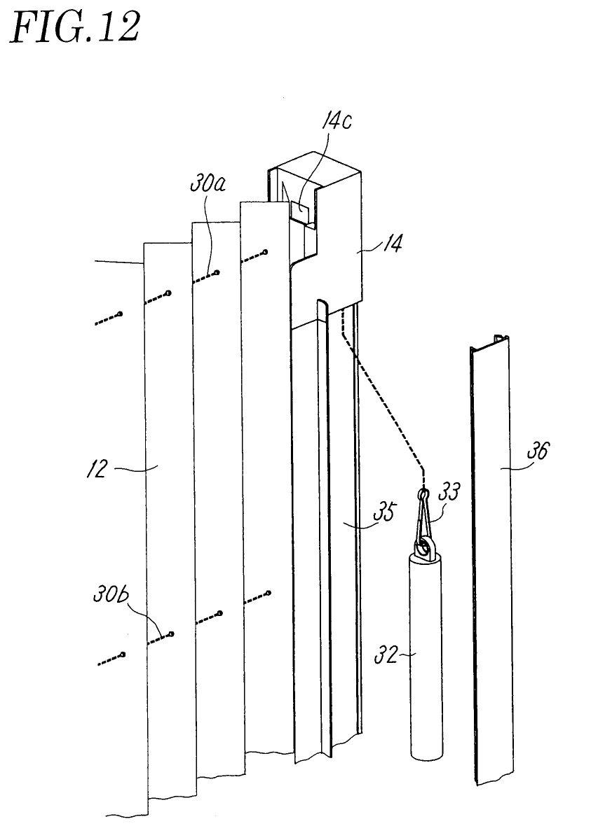

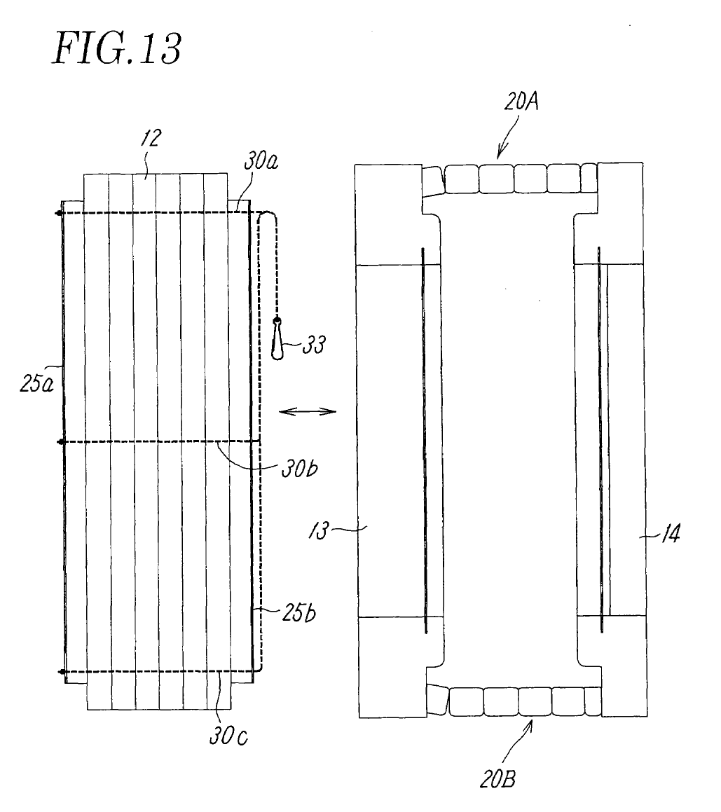

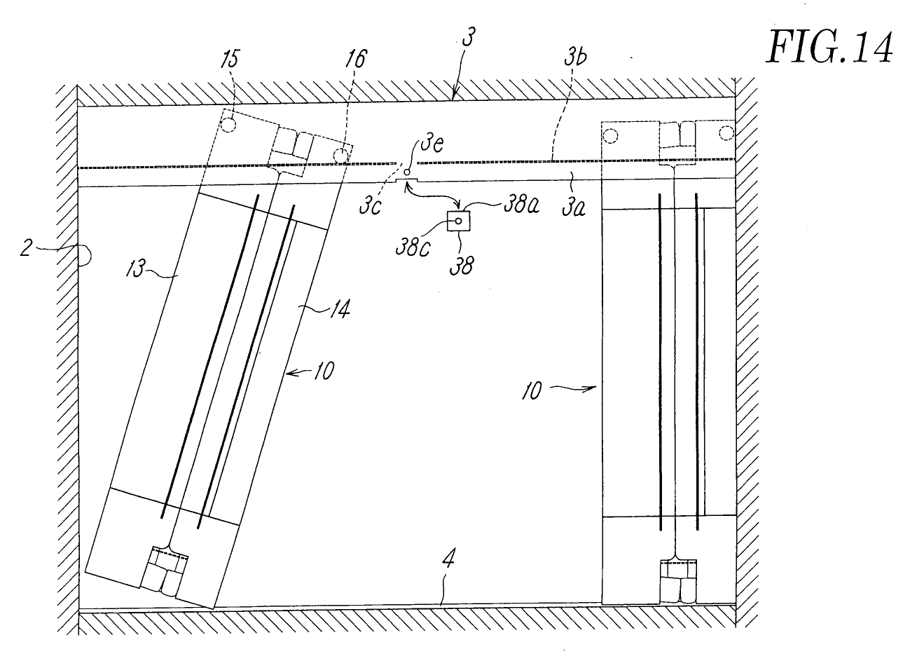

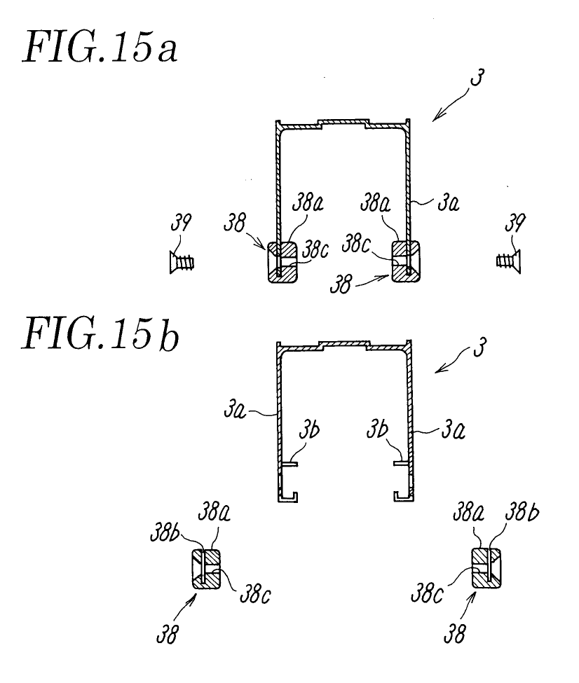

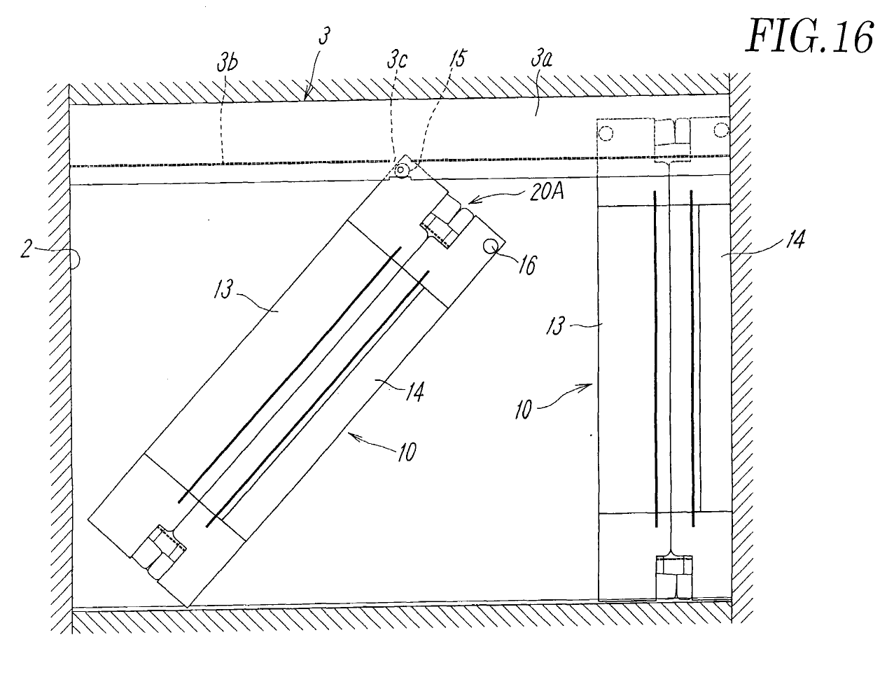

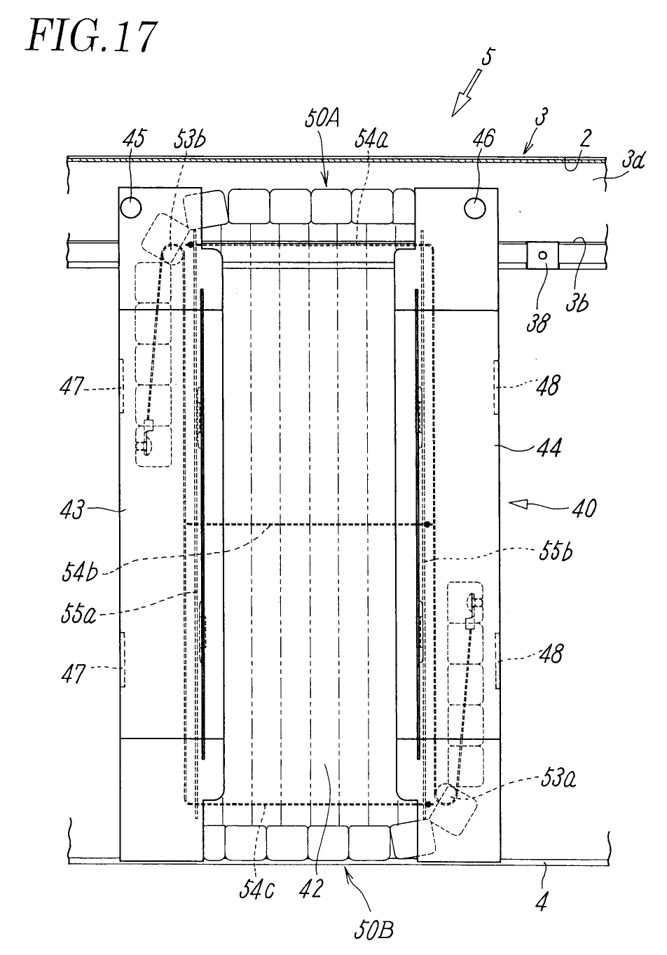

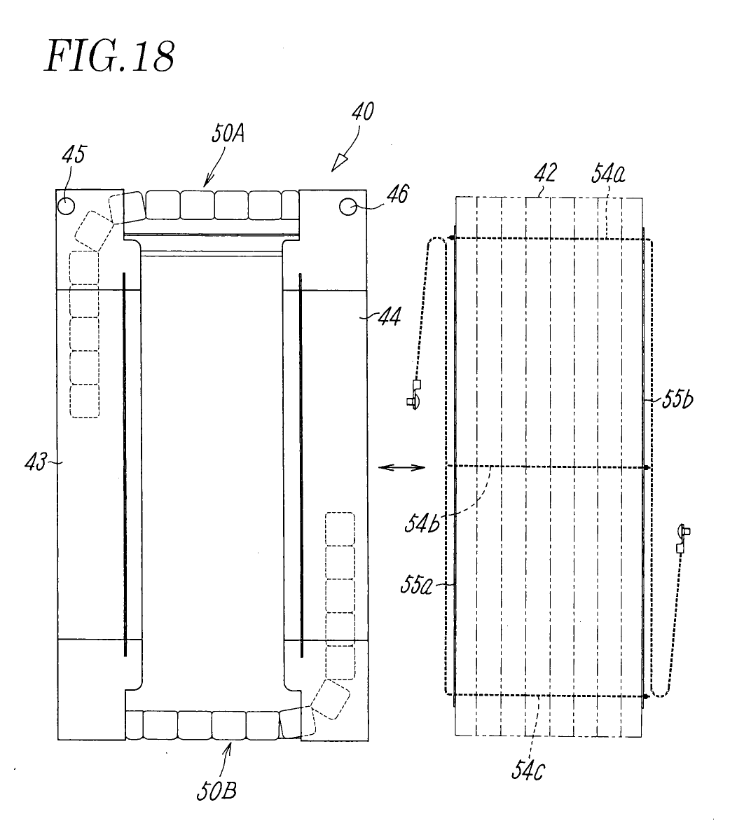

### REFERENCE NUMERALS

1, 5 screen device
2 opening for a building
3 lateral frame member
3b rail
3c slit
3d supporting groove
10, 40 screen unit
12, 42 screen
13, 14, 43, 44 vertical frame members
15, 16, 45, 46 projections
20A, 20B, 50A, 50B screen guides
21 guide piece
24, 54a-54c wire
25a, 25b, 55a, 55b mounting plates
28 mounting member
30a-30c wire
32 weight
35 operation opening
38 cap

1. A folding screen device comprising:
plurality of screen units each having a screen being expandable in an accordion manner by being folded alternately in the opposite direction at a number of bending portions provided in parallel at regular intervals and being openable and closable by pulling in the lateral direction; and movable vertical frame members being attached at both ends of the screen; the upper ends of the vertical frame members being fitted and held in a supporting groove of a lateral frame members of an opening of a building so as to be capable of sliding along the supporting groove,
the screen unit including screen guides moving out and into the interiors of the vertical frame members through the upper ends and the lower ends thereof in a bent state and being led along the upper end the lower end of the screen in an extended state for guiding the upper end and the lower end of the screen, and a horizontal movement mechanism for causing the movable vertical frame members to move in parallel during the opening and closing operation of the screen,
wherein bumping surfaces of the adjacent vertical frame members of the plurality of screen units are detachably connected to each other in the supporting groove where the vertical frame members are fitted and held in a freely slidable manner so that the screen units can be arranged in parallel in the opening of the building,
rails for preventing the upper ends of the screen units from coming apart by engaging with the projections provided on the upper ends of the respective vertical frame members are provided at the opening edges of the supporting groove of the upper lateral frame member on the upper portion of the opening of the building, and
the rails where the rollers roll are formed with slits for allowing passage of the rollers and the slits are closed by caps detachable with respect to the lateral frame member.

2. The folding screen device according to claim 1, wherein the pair of the screen guides in the screen unit are fixed at one ends thereof to the upper end and the lower end of one of the vertical frame members and are arranged so as to move out and into the interior of the other vertical frame member through the upper end and the lower end.

3. The folding screen device according to claim 2, wherein a parallel movement mechanism for causing the vertical frame members to move in parallel during opening and closing operation of the screen is configured by looped wire rotatably extended between the upper and lower portions in the interior of the vertical frame member which the screen guide moves out or into, and the portions thereof which move in the opposite directions are connected to ends of the respective screen guides.

4. The folding screen device according to claim 2, wherein the wire attached at one end thereof to the screen unit on the side of one of the vertical frame members, having inserted through the screen in the horizontal direction, is guided to the upper end of the other vertical frame member via redirecting means provided on the other vertical frame member, is suspended from the upper end into the other vertical frame member, and is attached with a weight at the distal end thereof in the other vertical frame member.

5. The folding screen device according to claim 4, wherein at least three of the screen units can be supported by the lateral frame member at the opening of the building and inhibiting means for inhibiting the screen from being automatically folded by the weight in a state in which the screen is extended is provided in at least a part of the screen unit.

6. The folding screen device according to claim 4, wherein the mounting plates fixed to both ends of the screen are disengageably engaged to the vertical frame members with the mounting members respectively,
the wire to be inserted through the screen and attached with the weight being suspended at the distal end thereof is fixed at one end thereof to the mounting plate engaged with one of the vertical frame member and is detachably attached with the weight at the distal end suspending from the upper end of the other vertical frame member, and
the other vertical frame member is provided with an operation opening for attaching and detaching the weight to the distal end of the wire and an insertion path for inserting the wire is configured to facilitate insertion and removal of the wire.

7. The folding screen device according to claim 1, wherein the pair of screen guides in the screen unit are fixed at one ends thereof to the upper end of one of the vertical frame members and the lower end of the other vertical frame member respectively and arranged so as to move out and into the interior of the opposed vertical frame members through the upper end and the lower end in a bent state.

8. The folding screen device according to claim 7, wherein the parallel movement mechanism for causing the vertical frame members to move in parallel during the opening and closing operation of the screen is configured in such a manner that the one end of the wire to be inserted through the upper half of the screen in the horizontal direction is fixed to the vertical frame member which the screen guide moves out therefrom and therein through the upper end thereof, and the other end of the wire is led toward the lower portion in the other vertical frame member and is redirected upward in the lower portion, and is fixed at the distal end thereof to the distal end of the screen guide which moves out and into the vertical frame member through the lower end thereof, while one end of the wire to be inserted through the lower half of the screen in the horizontal direction is fixed to the vertical frame member which the screen guide moves out therefrom and therein through the lower end thereof and the other end of the wire is led toward the upper portion in the other vertical frame member, is redirected downward at the upper portion, and is fixed to the distal end of the screen guide which moves out and into the vertical frame member through the upper end thereof.

9. The folding screen device according to claim 8, wherein the mounting plates fixed to both ends of the screen is disengageably engaged with the vertical frame member respectively with the mounting members, while the wires inserted through the upper half and the lower half of the screen are fixed to the mounting plates engaged at one ends thereof to the mounting plates engaged with the vertical frame members respectively, having inserted at the other ends thereof through the mounting plate of the other vertical frame member, are led to the lower portion and the upper portion along the mounting plate, are redirected to the opposite direction at the lower portion and the upper portion, are detachably fixed at the distal ends thereof to the distal ends of the screen guides which moves out and into the vertical frame member through the upper end and the lower end, so that the screen through which the wires are inserted can be separated from the both vertical frame members together with the mounting plates on the both ends thereof by separating the distal end of the respective wires from the distal ends of the screen guides.

10. The folding screen device according to claim 5, wherein the mounting plates fixed to both ends of the screen are disengageably engaged to the vertical frame members with the mounting members respectively,
the wire to be inserted through the screen and attached with the weight being suspended at the distal end thereof is fixed at one end thereof to the mounting plate engaged with one of the vertical frame member and is detachably attached with the weight at the distal end suspending from the upper end of the other vertical frame member, and
the other vertical frame member is provided with an operation opening for attaching and detaching the weight to the distal end of the wire and an insertion path for inserting the wire is configured to facilitate insertion and removal of the wire.
